(19) United States
(12) Patent Application Publication
(10) Pub. No.: US 2009/0248909 A1
(43) Pub. Date: Oct. 1, 2009

(54) Method and Apparatus for Simulating Consumer Electronic Control Functionality for Devices

(75) Inventors: Takashi Hironaka, San Diego, CA (US); Nick Colsey, Del Mar, CA (US); Peter Shintani, San Diego, CA (US); David Boyden, Escondido, CA (US); Toru Domukai, Aoba-ku (JP)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 12/056,039

(22) Filed: Mar. 26, 2008

(51) Int. Cl. G06F 3/00

(52) U.S. Cl. 710/18

(57) ABSTRACT

A High-Definition Multimedia Interface (HDMI) switch includes a plurality of peripheral device ports, each of which may be coupled to a corresponding peripheral device. The switch also includes a display device port for coupling to a display device. In one embodiment, the switch is configured to receive device identification information from one or more of the peripheral devices coupled to the peripheral device ports and to detect which of the peripheral device ports is an active port. The switch may then transmit the device identification information for the peripheral device coupled to the active port to a display device in accordance with an HDMI communication protocol, such as the consumer electronic control (CEC) protocol. In one embodiment, the peripheral device coupled to the active port is not configured to communicate according to the HDMI communication protocol.

### FIELD OF THE INVENTION

The present invention relates in general providing or simulating consumer electronic control (CEC) functionality to non-CEC devices.

### BACKGROUND

It is now typical for a user's home entertainment system to be made up of several peripheral consumer electronic devices, such as digital set top boxes (STBs), personal video recorders (PVRs), digital video disk (DVDs) and so on. These components are most often coupled to a single display, which is itself configured to select any one of its various available inputs at the touch of a button. Modern displays tend to ascribe a generic name to each such input, such as “Input 1,” “Input 2,” etc. The problem with this approach is that, in order to switch from one media source to another (e.g., from DVD to PVR), a user has to essentially remember which input is associated with which media source, or scroll through each and every one of the various available inputs until the desired input has been selected.

With that said, the incorporation of the High-Definition Multimedia Interface (HDMI) has become increasingly prevalent with display devices, as well as with peripheral consumer electronic devices. One advantage of HDMI capable devices is that they may be able exchange certain information with the display device. That is, under the HDMI specification there is an optional protocol referred to as the consumer electronic control (CEC) protocol. As fully defined in Supplement 1 of the HDMI Specification 1.3 (Jun. 22, 2006), the CEC protocol was designed to provide control functions between audio/video (A/V) devices that are connected via an HDMI cable. CEC assumes that all A/V source products in a system are directly or indirectly connected to a “root” display. In short, the CEC protocol is a one-wire, “party line” that connects up to ten source devices through standard HDMI cabling. The CEC protocol includes mechanisms for physical address discovery, logical addressing, arbitration, retransmission, broadcasting, and routing control. In short, this means that CEC-capable peripheral devices can provide identifying information to the display so that a user can determine exactly which device is the current source device (e.g., DVD, PVR. STB, etc.), and not just the generic name of the input (e.g., Input 1, Input 2, etc.).

Unfortunately, many HDMI peripheral devices have not been designed to comply with or otherwise make use of the CEC protocol. In such cases, the connected display device will be unable to properly detect the type of connected peripheral device, and instead will only be able to display the generic name of the input, as is the case with all non-HDMI devices. Thus, what is needed is a method and apparatus for providing or simulating CEC functionality for HDMI devices that are not otherwise CEC-capable.

### BRIEF SUMMARY OF THE INVENTION

Disclosed and claimed herein are methods and apparatus for providing or simulating peripheral device functionality, such as CEC functionality. In one embodiment, an HDMI switch includes HDMI peripheral device ports, each of which is coupled to a corresponding peripheral device, as well as an HDMI display device port coupled to a display device. The switch further includes a processor coupled to the HDMI peripheral device ports and to the HDMI display device port. The processor is configured to receive device identification information from the peripheral devices coupled to the HDMI peripheral device ports and to detect which of the HDMI peripheral device ports is an active port. In addition, the processor is configured to transmit the device identification information for the peripheral device coupled to the active port to a display device in accordance with an HDMI communication protocol. In one embodiment, the peripheral device coupled to the active port is not configured to communicate according to the HDMI communication protocol.

While in one embodiment the HDMI communication protocol is the CEC protocol, in other embodiments the HDMI communication protocol corresponds to any bi-directional communication protocol under the HDMI standard.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a simplified diagram of one embodiment of a system configured in accordance with the principles of the invention;

FIG. 2 is a simplified diagram of one embodiment of an HDMI switch and connected peripheral devices;

FIG. 3 depicts one embodiment of a graphical user interface for the HDMI switch of FIG. 2;

FIG. 4 is a simplified diagram of another embodiment of an HDMI switch; and

FIGS. 5A-5B is one embodiment of a process for carrying out one or more aspects of the invention.

### DETAILED DESCRIPTION OF EXEMPLARY EMBODIMENTS

### Disclosure Overview

One aspect of the present disclosure relates to an HDMI switch, which includes a plurality of peripheral device ports, each of which may be coupled to a corresponding peripheral device. The switch may also include a display device port for coupling to a display device. In one embodiment, the switch is configured to receive device identification information from one or more of the peripheral devices coupled to the peripheral device ports and to detect which of the peripheral device ports is an active port. The switch may then transmit the device identification information for the peripheral device coupled to the active port to a display device in accordance with an HDMI communication protocol, such as the consumer electronic control (CEC) protocol. In one embodiment, the peripheral device coupled to the active port is not configured to communicate according to the HDMI communication protocol.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc.

### Exemplary Embodiments

The present disclosure relates to the fact that most home entertainment systems are actually comprised of several source components with which the display device (i.e., the sink device) needs to interface, including for example a STB, PVR, home theater (HT) system, etc.

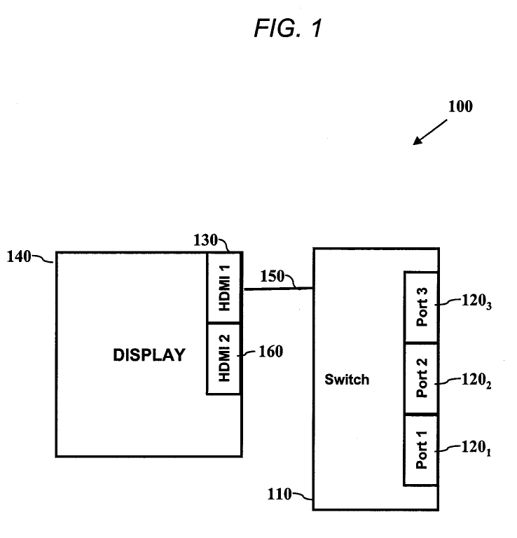

To that end, FIG. 1 depicts a system 100 configured in accordance with the principles of the invention. In particular, system 100 includes an HDMI switch 110 configured with three ports 120₁-120₃. It should of course be appreciated at the switch 110 may have fewer than three ports, or similarly more than three ports.

Switch 110 is further depicted as being coupled by HDMI connection 150 to an HDMI port 130 of a sink device in the form of display 140 (e.g., television). The display 140 may include additional HDMI ports, such as port 160. Additionally, the HDMI switch 110 may have CEC functionality for bi-directional CEC communication with the display 140. In another embodiment, the HDMI switch 110 may communicate with the display using any bi-directional communication protocol under the HDMI specification.

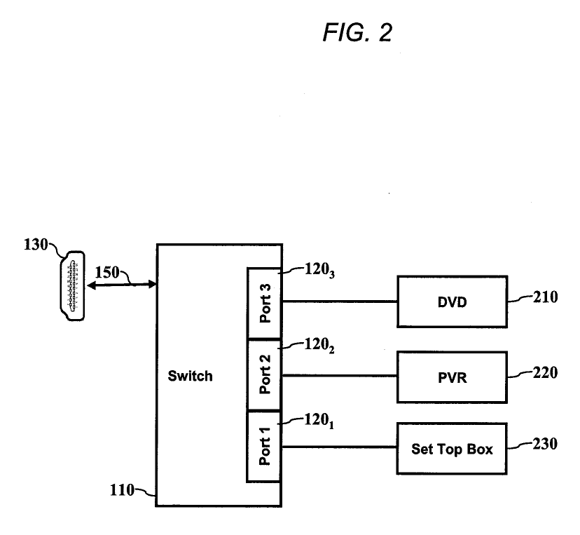

FIG. 2 depicts switch 110 being coupled to the HDMI port 130 of display 140, as well as to a plurality of peripheral source devices, including DVD 210, PVR 220 and STB 230. In particular, this enables the switch 110 to be used to change between source devices (e.g., DVD 210, PVR 220 and STB 230) using only one of the display device's HDMI ports (e.g., port 130). User selection of a given port (and hence of a given source device) may be made using a remote control device, a graphical user interface or user inputs on the switch 110 itself. In one embodiment, user selection of a given port results in selecting which one of the available HDMI peripheral device ports shall be used to provide an input signal to a connected display device (e.g., display 140). I

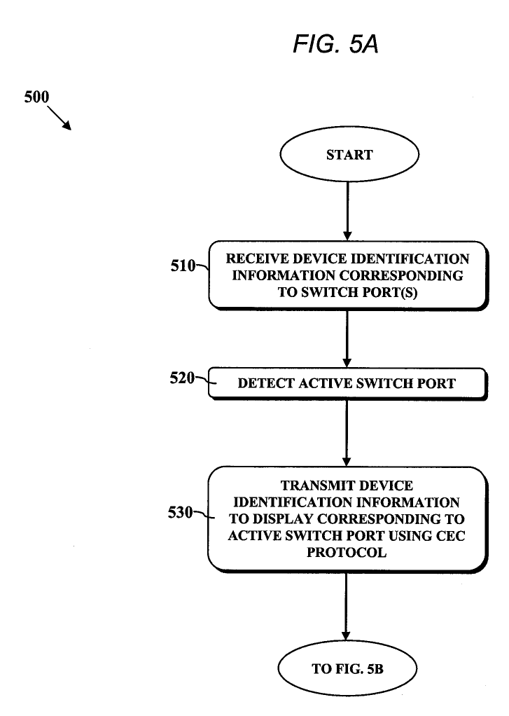

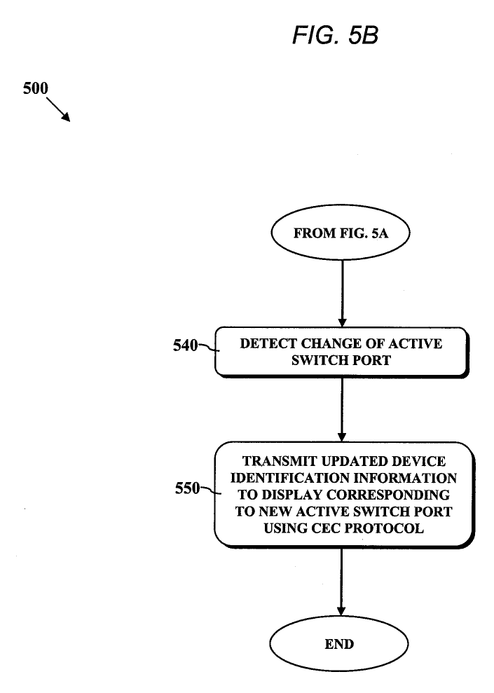

In addition, the switch 110 may be configured to communicate with the display device 140 using the CEC protocol, regardless of whether any of the connected peripheral devices are themselves CEC-capable. In this fashion, and as will be described in more detail below with reference to FIGS. 5A-5B, the switch 110 may be used to simulate CEC functionality for any one of the connected peripheral devices.

In one embodiment, the HDMI switch (e.g., switch 110) of the present disclosure may be user-configurable. In other words, a user may be provided with the ability to program or configure the various ports (e.g., ports 120₁-120₃) of the switch to correspond to particular types or names of connected peripheral devices. For example, in the embodiment depicted in FIG. 2 the DVD 210 has been connected to port 120₃. In order for the switch to be able to provide this device-specific information to the connected display device, a user may have programmed or otherwise configured the switch accordingly.

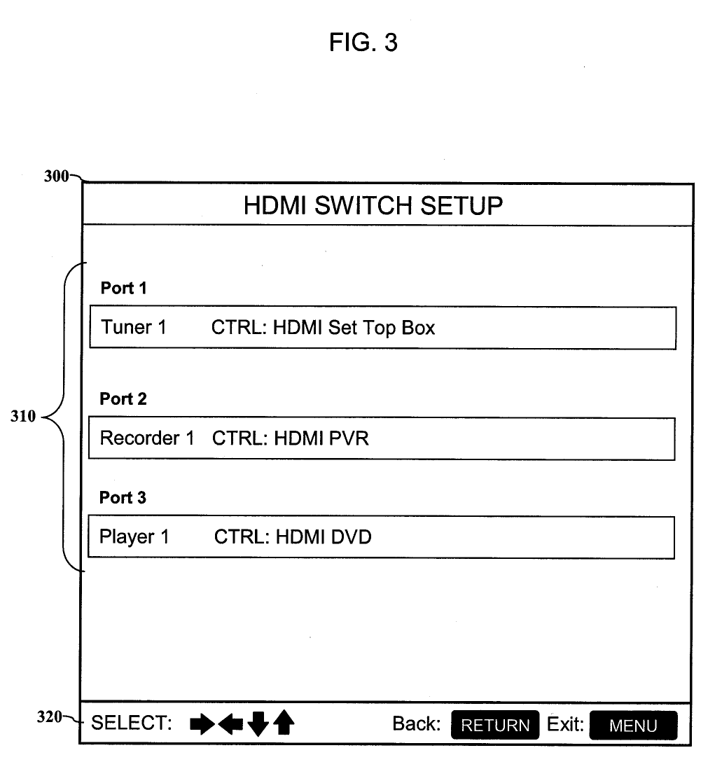

To that end, FIG. 3 depicts one embodiment of a graphical user interface 300 for entering device identification information corresponding to the embodiment of FIG. 2. In one embodiment, the user interface 300 may be generated by the switch (e.g., switch 110) and displayed on a connected display device (e.g., display device 140). In one embodiment, the user interface 300 allows the user to access a menu 310 for programming the switch's ports (i.e., ports 120₁-120₃). The menu 310 may be navigated by a user using on-screen navigation controls 320, or any other known means.

In the depicted embodiment, the user has selected the set top box option from the menu for Port 1 (i.e., port 120₁), thereby corresponding to the attached STB 230 (see FIG. 2). Similarly, the user has selected the PVR option from the menu for Port 2 (i.e., port 120₂) and the DVD option for Port 3 (i.e., port 120₃), corresponding to the attached PVR 220 and DVD 210, respectively. In this fashion, a user may provide device identification information to the switch corresponding to the peripheral devices that are connected to the plurality of HDMI peripheral device ports (e.g., ports 120₁-120₃). In one embodiment, the device identification information may relate to a type of device, as is the case in FIG. 3, or may include a user-defined name corresponding to the device (e.g., My DVD, John's PVR, etc.).

While FIG. 3 depicts one embodiment of a user interface, it should equally be appreciated that the interface need not be graphical, but may instead provide any form of indicator (e.g., light emitting diode, etc.).

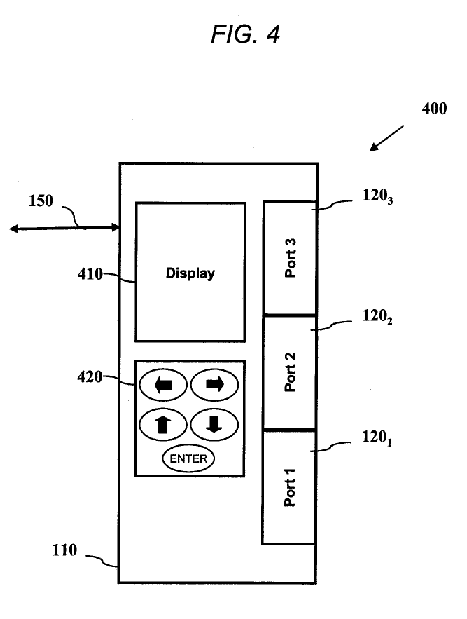

Referring now to FIG. 4, depicted is another embodiment of the HDMI switch 110 of FIGS. 1-2. In this embodiment, HDMI switch 400 is further configured with a display 410 and a user input 420. In one embodiment, a user is able to enter device identification information using the display 410 and user input 420, rather than a graphical user interface, such as the user interface 300 of FIG. 3. In short, a user may be similarly able to program the switch's ports (i.e., ports 120₁-120₃) by navigating a series of menus or options displayed by the display 410 using the user input 420 in order to provide device identification information to the switch corresponding to the peripheral devices that are connected to the plurality of HDMI peripheral device ports (e.g., ports 120₁-120₃).

Referring now to FIG. 5A, depicted is one embodiment of a process 500 for carrying out one or more aspect of the invention. In particular, process 500 begins at block 510 where the device identification information corresponding to one or more switch ports (e.g., ports 120₁-120₃) is received by an HDMI switch (e.g., switch 110). While in one embodiment, this device identification information may be provided by a user via a graphical user interface displayed on a connected display device (see e.g., FIG. 3), it may similarly be provided using any other known means (see e.g., FIG. 4). Moreover, it should be appreciated that the device identification information may correspond to a type of peripheral device that is connected to a given switch port, or may be a user-defined name for such device.

Process 500 continues to block 520 where the switch detects an active switch port. In one embodiment, this detection may occur upon powering up or initialization, and/or upon the user making a peripheral device selection. In any event, the active switch port corresponds to which of the available HDMI peripheral device ports will be used to provide an input signal to a connected display device. It should of course be appreciated that the user may select which of the plurality of HDMI peripheral device ports to make active using a remote control device, a graphical user interface or user inputs on the switch itself.

Once the active port has been detected, process 500 may then continue to block 530 where the device identification information corresponding to the active switch port may be sent using an HDMI communication protocol, such as the CEC protocol. In one embodiment, this device identification information may be sent to a connected display device (e.g., display device 140) over an HDMI connection (e.g., HDMI connection 150). Moreover, it should be appreciated that the for the device identification information to be transmitted may correspond to a device type or name for the peripheral device that is coupled to the active port. As such, the display device will be able to display device-specific information corresponding to the currently-selected source device instead of the generic input name, despite the fact that such source device may not be CEC-enabled.

Referring now to FIG. 5B, process 500 may continue to block 540 where a change in the active switch port is detected. In one embodiment, this may occur when the user selects a different one of the plurality of HDMI peripheral device ports to make active using, for example, a remote control device, a graphical user interface or user inputs on the switch itself. In any event, once a new switch port has been selected, process 500 may continue to block 550 where updated device identification information corresponding to the new active switch port may be sent using an HDMI communication protocol (e.g., CEC protocol) to the connected display device. Moreover, it should be appreciated that any subsequent changes to the active port may similarly trigger or initiate the transmission of updated device identification information. In this fashion, the currently-selected source device information may be displayed to a user as the user scrolls through the available inputs, despite the fact that one or more of the source devices may not be CEC-enabled.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A high-definition multimedia interface (HDMI) switch comprising:
a plurality of HDMI peripheral device ports, each of which is coupled to a corresponding peripheral device;
an HDMI display device port coupled to a display device; and
a processor coupled to the plurality of HDMI peripheral device ports and to the HDMI display device port, the processor configured to,
receive device identification information from each of the peripheral devices coupled to the plurality of HDMI peripheral device ports,
detect which of the plurality of HDMI peripheral device ports is an active port, and
transmitting device identification information for the peripheral device which is coupled to the active port, to a display device in accordance with an HDMI communication protocol, and wherein the peripheral device coupled to the active port is not configured to communicate according to the HDMI communication protocol.

2. The HDMI switch of claim 1, wherein the HDMI communication protocol is consumer electronic control (CEC) protocol.

3. The HDMI switch of claim 1, wherein the device identification information is provided by a user via a graphical user interface.

4. The HDMI switch of claim 1, wherein the processor is further configured to,
detect a user request to change to a new active port of the plurality of HDMI peripheral device ports, and
transmit, to the display device, updated device identification information corresponding to another of the peripheral devices corresponding to the new active port in accordance with the HDMI communication protocol.

5. A method for providing peripheral device functionality comprising:
receiving device identification information for a plurality of peripheral devices, wherein each of the plurality of peripheral devices are coupled to a corresponding plurality of high-definition multimedia interface (HDMI) switch ports;
detecting which of the plurality of HDMI ports is an active port; and
transmitting device identification information, corresponding to one of the plurality of peripheral devices that is couple to the active port, to a display device in accordance with an HDMI communication protocol, wherein the one of the plurality of peripheral devices that is coupled to the active port is not configured to communicate according to the HDMI communication protocol.

6. The method of claim 5, wherein the HDMI communication protocol is consumer electronic control (CEC) protocol.

7. The method of claim 5, wherein transmitting device identification information comprises transmitting device identification information in response to said detecting.

8. The method of claim 5, wherein the device identification information is provided by a user via a graphical user interface.

9. The method of claim 5, wherein the plurality of HDMI ports comprises an HDMI switch, and wherein the method further comprises connecting the HDMI switch to the display device.

10. The method of claim 5, further comprising:
detecting a user request to change to a new active port, and
transmitting, to the display device, updated device identification information corresponding to another one of the plurality of peripheral devices that is couple to the new active port in accordance with the HDMI communication protocol.

11. A computer program product comprising:
a computer readable medium having computer executable program code embodied therein to provide peripheral device functionality, the computer executable program product having:
computer executable program code to receive device identification information for a plurality of peripheral devices, wherein each of the plurality of peripheral devices are coupled to a corresponding plurality of high-definition multimedia interface (HDMI) switch ports,
computer executable program code to detect which of the plurality of HDMI ports is an active port, and
computer executable program code to transmit device identification information, corresponding to one of the plurality of peripheral devices that is couple to the active port, to a display device in accordance with an HDMI communication protocol, wherein the one of the plurality of peripheral devices that is coupled to the active port is not configured to communicate according to the HDMI communication protocol.

12. The computer program product of claim 11, wherein the HDMI communication protocol is consumer electronic control (CEC) protocol.

13. The computer program product of claim 11, wherein the computer executable program code to transmit device identification information comprises computer executable program code to transmit device identification information in response to detecting which of the plurality of HDMI ports is the active port.

14. The computer program product of claim 11, wherein the device identification information is provided by a user via a graphical user interface.

15. The computer program product of claim 11, wherein the plurality of HDMI ports comprises an HDMI switch configured to be connected to the display device.

16. The computer program product of claim 11, wherein the computer executable program product further comprises:
computer executable program code to detect a user request to change to a new active port, and
computer executable program code to transmit, to the display device, updated device identification information corresponding to another one of the plurality of peripheral devices that is couple to the new active port in accordance with the HDMI communication protocol.
